(19) United States
(12) Patent Application Publication
(10) Pub. No.: US 2024/0349179 A1
(43) Pub. Date: Oct. 17, 2024

(54) ARCHITECTURE ENHANCEMENTS FOR NETWORK SLICING

(71) Applicant: InterDigital Patent Holdings, Inc., Wilmington, DE (US)

(72) Inventors: Michael Starsinic, Newtown, PA (US); Quang Ly, North Wales, PA (US); Catalina Mladin, Hatboro, PA (US); Jiwan Ninglekhu, Royersford, PA (US)

(73) Assignee: InterDigital Patent Holdings, Inc., Wilmington, DE (US)

(21) Appl. No.: 18/691,805

(22) PCT Filed: Sep. 21, 2022
(86) PCT No.: PCT/US2022/076776

§ 371 Date: Mar. 13, 2024

Related U.S. Application Data
(60) Provisional application No. 63/246,485, filed on Sep. 21, 2021.

(51) Int. Cl. H04W 48/18; H04W 8/20; H04W 48/16; H04W 60/00; H04W 68/00

(52) U.S. Cl. CPC H04W 48/18; H04W 8/20; H04W 48/16; H04W 60/00; H04W 68/005

(57) ABSTRACT

A user equipment (UE) may detect that two or more of the slices that were requested by the UE cannot be served by the same access and mobility management function (AMF). Once the UE is able to determine that the multiple requested slices cannot be served by the same AMF, the UE may account for this incompatibility. For example, the UE may decide to only request compatible slices, or the UE may execute procedures with the network that allow the UE to simultaneously communicate with multiple AMFs. By allowing the UE to communicate with multiple AMFs, the UE may be able to utilize separate AMFs to register to slices that cannot be served by the same AMF. The system may allow for the UE to be paged by multiple AMFs.

### CROSS-REFERENCE TO RELATED APPLICATIONS

This application claims the benefit of U.S. Provisional Patent Application No. 63/246,485, filed on Sep. 21, 2021, entitled “Architecture Enhancements for Network Slicing,” the contents of which are hereby incorporated by reference herein.

### BACKGROUND

A network slice is a logical network that provides specific network capabilities and network characteristics. A network slice instance is a set of network function instances and the required resources (e.g., compute, storage and networking resources) which form a deployed Network Slice.

A tracking area (TA) is a set of cells. Tracking areas can be grouped into lists of tracking areas (TA lists), which can be configured on the user equipment (UE). Tracking areas (TA) is used for UE's access control, location registration, paging and mobility management.

A network function (NF) is a processing function in a network, which has defined functional behavior and defined interfaces. An NF can be implemented as a network element on a dedicated hardware, or as a software instance running on a dedicated hardware, or as a virtualized function instantiated on an appropriate platform, e.g., on a cloud infrastructure. A NF instance is an identifiable instance of an NF.

This background information is provided to reveal information believed by the applicant to be of possible relevance. No admission is necessarily intended, nor should be construed, that any of the preceding information constitutes prior art.

### SUMMARY

A wireless transmit/receive unit (WTRU) may detect that one or more of the multiple slices that were requested by the WTRU cannot be served by the same AMF. Once the WTRU is able to determine that the multiple requested slices cannot be served by the same AMF, the WTRU may take steps to account for this incompatibility. For example, the WTRU may decide to only request compatible slices, or the WTRU may execute procedures with the network that allow the WTRU to simultaneously communicate with multiple AMFs. By allowing the WTRU to communicate with multiple AMFs, the WTRU may be able to utilize separate AMFs to register to slices that cannot be served by the same AMF. The system may allow for the WTRU to be paged by multiple AMFs. The 5G system may be enhanced so that the network may provide the WTRU with more than 16 configured slices.

In an example, a memory of a WTRU may be coupled with a processor. The memory may store executable instructions that when executed by the processor cause the processor to effectuate operations comprising: sending a registration request message, wherein the registration request message comprises a requested network slice selection assistance information (NSSAI), wherein the requested NSSAI comprises an indication of a plurality of network slices; receiving a registration accept message, wherein the registration accept message indicates that one or more of the plurality of network slices are allowed with a first access and mobility management function (AMF) and at least one of the plurality of network slices is rejected, wherein the registration accept message indicates that a slice was rejected based on the first AMF being unable to serve the rejected slice and the one or more of the allowed network slices; and sending a second registration request message to a second AMF, wherein the second registration request message comprises a second requested NSSAI, wherein the second requested NSSAI indicates a request for the rejected slice.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 illustrates an exemplary 5G system service-based architecture;

FIG. 2 illustrates an exemplary non-roaming 5G system architecture in reference point representation;

FIG. 3 illustrates an exemplary enhanced registration procedure;

FIG. 4 illustrates an exemplary registration to a secondary AMF;

FIG. 5 illustrates an exemplary registration procedure for extending the configured NSSAI;

FIG. 6 illustrates an exemplary display that may be generated based on the methods, systems, and devices for architecture enhancements for network slicing;

FIG. 7A illustrates an example communication system;

FIG. 7B illustrates an exemplary system that includes RANs and core networks;

FIG. 7C illustrates an exemplary system that includes RANs and core networks;

FIG. 7D illustrates an exemplary system that includes RANs and core networks;

FIG. 7E illustrates another example communications system;

FIG. 7F is a block diagram of an example apparatus or device, such as a WTRU; and

FIG. 7G is a block diagram of an exemplary computing system.

### DETAILED DESCRIPTION

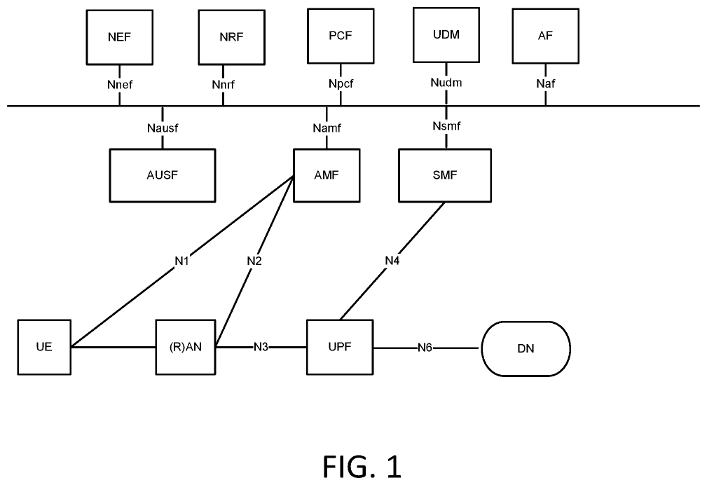

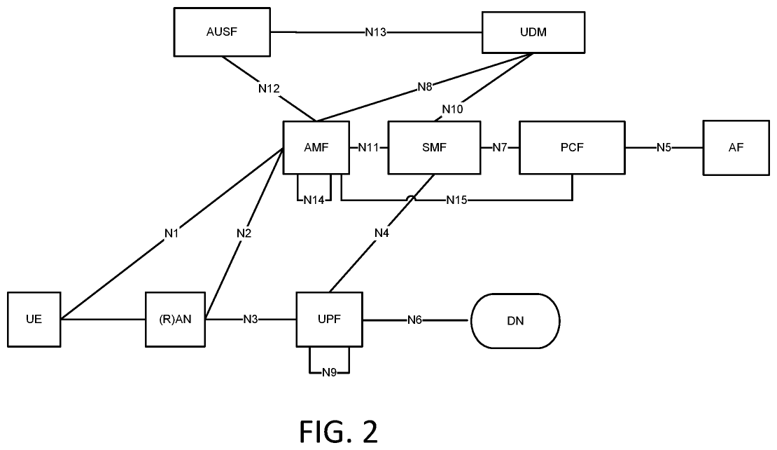

FIG. 1 illustrates an exemplary non-roaming reference architecture with service-based interfaces within the control plane. FIG. 2 illustrates an exemplary 5G System architecture in the non-roaming case, using the reference point representation showing how various network functions interact with each other.

The mobility management and session management functions are separated. A single N1 NAS connection may be used for both registration management and connection management and for session management (SM) related messages and procedures for a UE (e.g., a WTRU). The single N1 termination point is located in AMF. The AMF forwards SM related NAS information to the SMF. AMF handles the registration management and connection management part of NAS signaling exchanged with the UE. SMF handles the Session management part of NAS signaling exchanged with the UE.

The 5G System architecture may be defined to support data connectivity and services enabling deployments to use techniques such as network function virtualization and software defined networking. The 5G System architecture may leverage service-based interactions between Control Plane (CP) Network Functions where identified.

An NF may be a processing function in a network, which has defined functional behavior and defined interfaces. An NF may be implemented as a network element on a dedicated hardware, or as a software instance running on a dedicated hardware, or as a virtualized function instantiated on an appropriate platform, e.g., on a cloud infrastructure.

Network Slicing in the 5G system: A network slice may be defined as a logical network that provides specific network capabilities and network characteristics. A network slice within a PLMN may include the core network control plane and user plane network functions. A network slice instance may be defined as a set of network function instances and the required resources (e.g., compute, storage, or networking resources) which form a deployed network slice.

Network slices may differ for supported features and network function optimizations, in which case such network slices may be of different slice/service types. The operator may deploy multiple network slice instances delivering the same features but for different groups of UEs, e.g., as they deliver a different committed service or because they are dedicated to a customer, in which case such network slices may be of the same slice/service type but are distinguished through different slice differentiators.

The network may serve a single UE with one or more network slice instances simultaneously via a 5G-AN and associated with at most eight different S-NSSAIs in total, regardless of the access type(s) over which the UE is registered (i.e., 3GPP Access or N3GPP Access). The AMF instance serving the UE logically may belong to each of the network slice instances serving the UE, e.g., this AMF instance is common to the network slice instances serving a UE.

Identification and selection of a network slice: A network slice may be identified by an S-NSSAI, which may be comprised of: 1) A slice/service type (SST), which refers to the expected network slice behavior in terms of features and services; or 2) a slice differentiator (SD), which may be information that complements the slice/service type(s) to differentiate amongst multiple network slices of the same slice/service type.

An S-NSSAI may have standard values (e.g., such S-NSSAI is only comprised of an SST with a standardized SST value, and no SD) or non-standard values (e.g., such S-NSSAI is comprised of either both an SST and an SD or only an SST without a standardized SST value and no SD). An S-NSSAI with a non-standard value may identify a single network slice within the PLMN with which it is associated. An S-NSSAI with a non-standard value may not be used by the UE in access stratum procedures in any PLMN other than the one to which the S-NSSAI is associated. Table 1 shows the standardized SST value.

The NSSAI is a collection of S-NSSAIs. An NSSAI may be a configured NSSAI, a requested NSSAI or an allowed NSSAI. There can be at most eight S-NSSAIs in allowed and requested NSSAI sent in signaling messages between the UE and the network. The requested NSSAI signaled by the UE to the network allows the network to select the serving AMF, network slice(s), or network slice instance(s) for this UE.

Based on the operator's operational or deployment needs, a network slice instance may be associated with one or more S-NSSAIs, and an S-NSSAI may be associated with one or more network slice instances. Multiple Network Slice instances associated with the same S-NSSAI may be deployed in the same or in different Tracking Areas. When multiple network slice instances associated with the same S-NSSAI are deployed in the same tracking areas, the AMF instance serving the UE may logically belong to (e.g., be common to) more than one network slice instance associated with this S-NSSAI.

Based on the requested NSSAI (if any) and the subscription information, the 5GC is responsible for selection of a Network Slice instance(s) to serve a UE including the 5GC control plane and user plane network functions corresponding to this network slice instance(s).

The (R)AN may use requested NSSAI in access stratum signaling to handle the UE control plane connection before the 5GC informs the (R)AN of the allowed NSSAI. The requested NSSAI may be used by the RAN for AMF selection. The UE may not include the requested NSSAI in the RRC resume when the UE asks to resume the RRC connection and is CM-CONNECTED with RRC inactive state.

When a UE is successfully registered over an access type, the CN informs the (R)AN by providing the allowed NSSAI for the corresponding access type.

Standardized SST values provide a way for establishing global interoperability for slicing so that PLMNs can support the roaming use case more efficiently for the most commonly used slice/service types. The SSTs which are standardized are in the following Table 1.

TABLE 1
Standardised SST values

| Slice/Service | SST | |
|---|---|---|
| type | value | Characteristics |
| eMBB | 1 | Slice suitable for the handling of 5G |
| | | enhanced Mobile Broadband. |
| URLLC | 2 | Slice suitable for the handling of ultra- |
| | | reliable low latency communications. |
| MIoT | 3 | Slice suitable for the handling of massive IoT. |
| V2X | 4 | Slice suitable for the handling of V2X services. |

Configured NSSAI may be the NSSAI provisioned in the UE applicable to one or more PLMNs. A configured NSSAI may be configured by a serving PLMN and apply to the serving PLMN. There is at most one configured NSSAI per PLMN. The configured NSSAI is a list of slices that the UE may request from the PLMN. There may be up to 16 slices in the configured NSSAI.

A default configured NSSAI may be configured by the HPLMN and that applies to any PLMNs for which no specific configured NSSAI has been provided to the UE. The value(s) used in the default configured NSSAI may be expected to be commonly decided by all roaming partners. The default configured NSSAI, if it is configured in the UE, is used by the UE in a serving PLMN only if the UE has no configured NSSAI for the serving PLMN. The UE may be pre-configured with the default configured NSSAI.

Requested NSSAI is the NSSAI provided by the UE to the serving PLMN during registration. The S-NSSAIs in the requested NSSAI are part of the configured or allowed NSSAIs applicable for this PLMN, when they are available. If no configured NSSAI and allowed NSSAI for the PLMN are available, the S-NSSAIs in the requested NSSAI correspond to the default configured NSSAI, if configured in the UE.

The requested NSSAI signaled by the UE to the network may allow the network to select the serving AMF, network slice(s) and network slice instance(s) for this UE. Based on the requested NSSAI (if any) and the subscription information, the 5GC may be responsible for selection of a network slice instance(s) to serve a UE including the 5GC control plane and user plane network functions corresponding to this network slice instance(s). The (R)AN may use requested NSSAI in access stratum signaling to handle the UE control plane connection before the 5GC informs the (R)AN of the allowed NSSAI.

Allowed NSSAI may be the NSSAI provided by the serving PLMN during (e.g., a registration procedure), indicating the S-NSSAIs values the UE may use in the serving PLMN for the current registration area. Upon successful completion of a UE's registration procedure over an access type, the UE may obtain from the AMF an allowed NSSAI for this access type, which may include one or more S-NSSAIs and, if needed, their mapping to the HPLMN S-NSSAIs. These S-NSSAIs may be valid for the current registration area or access type provided by the AMF the UE has registered with and may be used simultaneously by the UE (up to the maximum number of simultaneous network slice instances or PDU sessions)

The mapping of allowed NSSAI may be the mapping of each S-NSSAI of the allowed NSSAI for the serving PLMN to the HPLMN S-NSSAIs.

The mapping of configured NSSAI may be the mapping of each S-NSSAI of the configured NSSAI for the serving PLMN to the HPLMN S-NSSAIs.

AMF selection is a procedure that may be performed by the 5G-AN (e.g., the base station). The procedure may be used to select an AMF instance to serve a UE.

AMF selection may also be a procedure that may be performed by the AMF. The AMF may perform the procedure to select another AMF to serve a UE when it determines that it may not be an appropriate AMF to serve the UE. For example, this may happen if the UE attempts to register to a different network slice.

When the 5G-AN performs AMF selection, the 5G-AN considers what slices the UE has requested and other information, such as local operator policies, the UE's properties (e.g., RAT type), etc.

Registration over both 3GPP and non-3GPP Access: For a given serving PLMN there is one RM context for a UE for each access. The UDM manages separate/independent UE Registration procedures for each access.

When served by the same PLMN for 3GPP and non-3GPP accesses, a UE is typically served by the same AMF. In this scenario, the UE is assigned a 5G-GUTI that is common to both 3GPP and non-3GPP accesses. This 5G-GUTI is globally unique. The UE also has a registration state per access type (3GPP/Non-3GPP).

When the UE is already registered via one access network (e.g., 3GPP or non-3GPP) and may attempt to register via the other access network (e.g., 3GPP or non-3GPP), the UE may provide using the second access network the 5G-GUTI that was provided via the first access network. The access network (e.g., base station) then uses that 5G-GUTI to ensure that the AMF that is serving the UE via the first access network may be selected to serve the UE via the second access network. 5G-GUTI

The AMF may allocate a 5G Globally Unique Temporary Identifier (5G-GUTI) to the UE that may be common to both 3GPP and non-3GPP access. It is possible to use the same 5G-GUTI for accessing 3GPP access and non-3GPP access security context within the AMF for the given UE. An AMF may re-assign a new 5G-GUTI to the UE at any time.

The 5G-GUTI is structured as:
<5G-GUTI>:=<GUAMI> <5G-TMSI>
where GUAMI identifies one or more AMF(s).

The Globally Unique AMF ID (GUAMI) is structured as:
<GUAMI>:=<MCC> <MNC> <AMF Region ID> <AMF Set ID> <AMF Pointer>

The 5G-S-TMSI is the shortened form of the GUTI to enable more efficient radio signaling procedures (e.g., during Paging and Service Request) and is defined as:
<5G-S-TMSI>:=<AMF Set ID> <AMF Pointer> <5G-TMSI>

In the 5G System, the AMF instance serving the UE logically belongs to each of the network slice instances serving the UE. In other words, this AMF instance is common to the network slice instances serving a UE. The fact that the AMF instance is common to all of the network slice instances serving a UE is a limitation in the 5G system design. It is a limitation because it requires that network resources (e.g., the AMF) to be shared between certain network slices. Sharing resources between network slices is undesirable for both resource allocation and security reasons. This disclosed subject matter may address the architecture updates to allow the UE to detect that the slices that the UE requested cannot be served by a single AMF and to allow the UE to communicate with multiple AMFs via a single access (e.g., 5G NR) connection. By enhancing the system to allow the UE to communicate/register with multiple AMFs, the UE will be able to registers with network slice instances that are served by separate AMFs. The 5G system may include multiple AMFs that may send paging messages to the same UE.

Another limitation of the 5G system design is that although a UE may be subscribed to more than 16 network slices (e.g., S-NSSAIs), the configured NSSAI that is sent to the UE may include no more than 16 slices (e.g., S-NSSAIs). This 16 slices limit in the configured NSSAI is 5G system limitation in the sense that the UE may not always be able to select a slice that it is subscribed to. For example, the UE may be subscribed to 20 slices, but at any given time can only choose slices from the 16 slices that are in the UE's configured NSSAI.

The above issues may be addressed by the following. Described herein is how the UE may receive a notification from the network that two or more of the slices that were requested by the UE cannot be served by the same AMF.

Further described herein are what actions the UE may take when the UE is notified by the network that two or more of the slices that were requested by the UE cannot be served by the same AMF. The UE may execute procedures with the network that allow the UE to simultaneously communicate with multiple AMFs. The concepts of a primary and secondary AMF are introduced. By allowing the UE to communicate with multiple AMFs, the UE may be able to utilize separate AMFs to register to slices that cannot be served by the same AMF. The system may be enhanced so that the UE may be paged by more than one AMF and describes how the UE's connected mode state may be maintained, or monitored, by multiple AMFs.

Also described herein is how the 5G system may be enhanced so that the network can provide the UE with more than 16 configured slices.

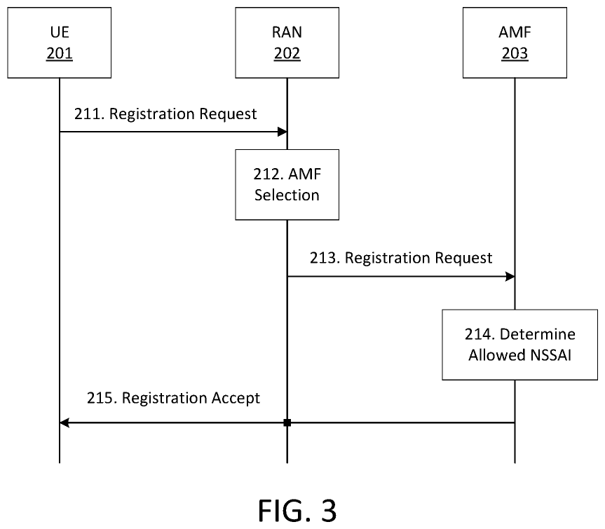

The 5G registration procedure may allow the UE to detect that two or more slices that were requested by the UE cannot be served by the same AMF. The registration procedure is shown in FIG. 3.

In step 211 of FIG. 3, UE 201 sends a registration request to AMF 203. The requested NSSAI includes multiple slices (e.g., slices A, B, C, and D). The request may indicate if the UE 201 is capable of registering to more than one AMF at the same time. The network may use this indication to determine whether the network should indicate to UE 201 that a slice was rejected because it cannot be served by the same AMF that serves one of the other allowed slices. Alternatively, the indication may indicate to the network how many connection management (CM) states UE 201 may maintain.

In step 212 of FIG. 3, RAN node 202 (e.g., NG-RAN node) may perform AMF selection. RAN node 202 may consider the slices of the requested NSSAI when selecting AMF 203. In other words, RAN node 202 may attempt to select AMF 203 that is capable of serving the slices in the requested NSSAI. If there is not a AMF 203 available that may serve all of the slices of the requested NSSAI, RAN node 202 may select AMF 203 that can serve only a subset of the slices of the requested NSSAI.

In step 213 of FIG. 3, RAN node 202 may forward the NAS registration request of step 231 to the selected AMF 203.

In step 214 of FIG. 3, AMF 203 may determine, based on local policies, that at least some of the requested slices are not able to be served by the same AMF. AMF 203 may also determine, based on local policies, which slices to allow and which slices to reject. For example, AMF 203 may determine to allow slices A, B, and C and AMF 203 may determine to reject slice D since a local policy (e.g., configuration information) indicates that a single AMF cannot serve slices C and D or that the AMF cannot serve slice D.

In step 215 of FIG. 3, the UE receives the registration accept message. The registration accept message may include an allowed NSSAI which indicates that only a subset of the UE 201's requested slices may be allowed (e.g., slices A, B, and C) and that one slice (e.g., slice D) was rejected. AMF 203 may send to UE 201 a registration accept response which may include a rejection cause code for slice D that indicates that slice D was rejected because it cannot be served by the same AMF that serves one of the other allowed slices.

A result of indicating to UE 201 that one slice (e.g., slice D) was rejected because it cannot be served by the same AMF that serves one or more of the other allowed slices is that UE 201 may be aware that it may be permitted to register to slice D, in which UE 201 may take one or more subsequent actions in order to register with slice D. The indication may include additional information (e.g., whether slice D is served by the current AMF, whether the choice of slice D is incompatible with other slice choices, etc.). The rejection cause code may further indicate which slices an AMF 203 cannot serve with slice D.

An example of a subsequent action that UE 201 may take is, if the rejection cause code indicates which slices cannot be served by the same AMF, UE 201 may choose to remove once slice (e.g., slice C) from its requested NSSAI and add the rejected slice (e.g., slice D) back to its requested NSSAI.

Another example of a subsequent action that UE 201 may take is that UE 201 may choose to execute a new procedure that allows UE 201 to establish a second NAS connection with a second AMF in order to register with the rejected slice (e.g., slice D).

A new registration request type may be defined for “Slice Addition”. UE 201 may send a registration request to the network with the registration type set to “Slice Addition” when UE 201 wants to register to a slice that is not in its allowed NSSAI, cannot (e.g., not allowed or capable) be served by primary AMF 204 that is currently serving UE 201, or cannot be served by an available AMF simultaneously with one or more of the UE's currently allowed slices. Alternatively, an existing registration type (e.g., the mobility registration type or period registration type) may be used and UE 201 may send a separate indication to the network that indicates that UE 201 wants to register to a slice that is not in its allowed NSSAI, cannot be served by primary AMF 204 that is currently serving UE 201, or cannot be served by an available AMF simultaneously with one or more of UE 201's currently allowed slices.

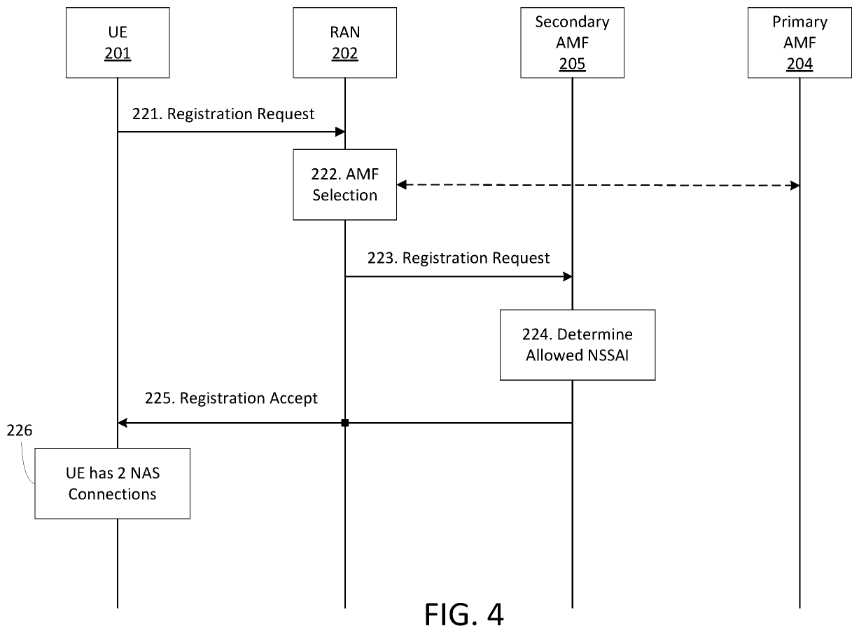

An example of a registration procedure is shown in FIG. 4. The registration type may be set to “Slice Addition”. In step 221 of FIG. 4, UE 201 sends a NAS registration request to RAN node 202. The NAS registration request may be included in an RRC Message to the RAN node 202. The registration type may be set to “Slice Addition” and the requested NSSAI may indicate one or more slices that UE 201 would like to register to but cannot be served by primary AMF 204 (e.g., slice D). The message may further include the 5G-GUTI that was assigned to UE 201 by primary AMF 204. Primary AMF 204 may currently serve UE 201. The message may further indicate if UE 201 previously received an indication that primary AMF 204 cannot serve the requested slice(s) or if UE 201 would like to establish a NAS connection with a second AMF (e.g., secondary AMF 205) it is required in order to obtain access to the requested slice.

In step 222 of FIG. 4, RAN node 202 may perform an AMF selection procedure. This procedure may be used to select secondary AMF 205 for UE 201. Secondary AMF 205 may be able to serve the slices that UE 201 is attempting to register to (e.g., slice D). RAN node 202 may use the slices of the requested NSSAI (e.g., the S-NSSAI of slice D) to determine secondary AMF 205 to serve UE 201. If the RAN node 202 is not able to determine a secondary AMF, RAN node 202 may request that primary AMF 204 select a secondary AMF 205. Alternatively, RAN node 202 may use local policies to select a default AMF (not shown) and request that the default AMF select secondary AMF 205. RAN node 202 may send a message (e.g., NGAP message) to primary AMF 204 or to a default AMF, and include the UE's 5G GUTI and the S-NSSAI(s) of the slices that UE 201 is attempting to register to (e.g., slice D). Primary AMF 204 may reply with confirmation that the primary AMF 204 is not able to serve the requested slice(s) and the reply may include the identities of one or more AMF(s) (e.g., secondary AMFs 205) that can serve the requested slice(s) and may be selected by RAN node 202 as secondary AMF 205 for UE 201. RAN node 202 may then select secondary AMF 205 from a list of AMFs that were provided by the primary AMF 204 or by a default AMF. Once secondary AMF 205 is chosen, RAN node 202 may forward the registration request to secondary 205 AMF. Alternatively, instead of sending an NGAP message to the primary AMF 204 or to a default AMF, RAN node 204 may invoke a service operation of the NRF and include the UE's 5G GUTI and the S-NSSAI(s) of the slices that UE 201 is attempting to register to (e.g., slice D). The NRF may respond to the service invocation of RAN node 202 with the identities of one or more AMF(s) that may serve the requested slice(s) and may be selected by RAN node 202 as secondary AMF 205 for UE 201.

In step 223 of FIG. 4, secondary AMF 205 may receive the registration request with the registration type set to “Slice Addition”. The message includes the 5G-GUTI that was assigned to UE 201 by primary AMF 204. Secondary AMF 205 determines that it is able to register UE 201 to the requested slice(s) (e.g., slice D) and serve as secondary AMF 205.

In step 224 of FIG. 4, secondary AMF 205 may determine an allowed NSSAI for UE 201.

In step 225 of FIG. 4, secondary AMF 205 may send a registration accept message to UE 201. The registration accept message may include a 5G-GUTI that was assigned by secondary AMF 205. The 5G-GUTI that is assigned by the secondary AMF 205 may be referred to as a secondary 5G-GUTI.

At step 226, UE 201 may utilize two NAS connections. A first NAS connection with primary AMF 204 and a second NAS connection with secondary AMF 205. Each NAS connection is associated with a 5G-GUTI (e.g., a primary 5G-GUTI and a secondary 5G-GUTI).

When UE 201 is in idle mode, UE 201 may monitor multiple (e.g., two) separate paging occasions. For example, one paging occasion may be based on the 5G-GUTI that was assigned by primary AMF 204 and the second paging occasion may be based on the 5G-GUTI that was assigned by secondary AMF 205. It is noted that this approach may be inefficient if the paging occasions are not close in time, then UE 201 may need to stay awake more often in order to monitor multiple paging occasions.

Alternatively, UE 201 may only use the 5G-GUTI from primary AMF 204 (e.g., the primary 5G-GUTI) to determine what paging occasion to monitor. If secondary AMF 205 determines to page UE 201, secondary AMF 205 may then provide the primary 5G-GUTI to RAN node 202 in the paging request. RAN node 202 may then use the primary 5G-GUTI to determine the UE's paging occasion (PO). When secondary AMF 205 pages UE 201, the primary 5G-GUTI is used to determine UE 201's PO, however the secondary 5G-S-TMSI may be placed in the paging message. Thus, UE 201 may use the primary 5G-GUTI to determine what paging occasion to monitor but may check the paging message for both the primary and secondary 5G-S-TMSI's.

Primary AMF 204 may update, or change, the UE 201's 5G-GUTI. When this occurs, UE 201 may inform secondary AMF 205 of the new 5G-GUTI so that secondary AMF may know what identifier to include future paging requests. When primary AMF 204 updates the UE's 5G-GUTI, UE 201 may send a NAS registration update to secondary AMF 205 with the new 5G-GUTI.

Alternatively, when UE 201 sends a registration request to the secondary AMF 205, UE 201 may send only part of the primary 5G-S-TMSI to the secondary AMF 205 instead of the complete 5G-GUTI. Alternatively, UE 201 may send only the part of the primary 5G-S-TMSI that is used to determine UE 201's paging occasion.

UE 201 may maintain separate connection management (CM) states for each AMF that it communicates with. Alternatively, UE 201 may maintain a single CM state and associate the CM state with primary AMF 204. When UE 201 registers with secondary AMF 205, secondary AMF 205 may use primary 5G-GUTI that was provided by UE 201 to determine the identity of primary AMF 204 and subscribe to UE 201's CM state which may be maintained in primary AMF 204. Secondary AMF 205 may use the state information, indications, or notifications, that are obtained from primary AMF 204 to determine if UE 201 is in the CM-CONNECTED or CM-IDLE state.

Alternatively, UE 201 may maintain a single CM state and associate the CM state with primary AMF 204. When UE 201 registers with secondary AMF 205, secondary AMF 205 may subscribe to RAN node 202 (or other network node) to receive notifications when the UE 201's access network (AN) signaling connection is established or released. Secondary AMF 205 may consider UE 201 to be in the CM-CONNECTED state when UE 201 receives a notification (e.g., from RAN node 202) that UE 201's AN signaling connection is established and secondary AMF 205 may consider UE 201 to be in the CM-IDLE state when UE 201 receives a notification from RAN node 202 that UE 201's AN signaling connection is released. When UE 201 successfully registers to secondary AMF 205, RAN node 202 may also notify primary AMF 204 that UE 201 is registered to secondary AMF 205 so that primary AMF 204 may subscribe, or request, that RAN node 202 notify primary AMF 204 when UE 201 establishes or releases an AN signaling connection.

When UE 201 sends a registration request to the network, UE 201 may indicate to the network (e.g., AMF 205) how many slices (e.g., S-NSSAIs) that UE 201 is capable of storing in UE 201's Configured NSSAI. If UE 201 provides no such indication in the registration message, the network may assume that UE 201 is capable of storing 16 S-NSSAIs in the configured NSSAI. The indication from UE 201 may be encoded as part of the 5GMM Capability Information Element or encoded as part of a new information element. The 5GMM Capability Information Element is defined in TS 24.501. The encoding of the indication may be a 3-bit value where the value 000 indicates that UE 201 is able to store 16 S-NSSAIs in the configured NSSAI. The encoding 001 may indicate that UE 201 is able to store 20 S-NSSAIs in the configured NSSAI. Each encoding may represent an increase of 4 additional S-NSSAIs that UE 201 is capable of storing in the configured NSSAI (e.g., an encoding of 010 may indicate that UE 201 is able to store 24 S-NSSAIs in the configured NSSAI and an encoding of 011 may indicate that UE 201 is able to store 28 S-NSSAIs in the configured NSSAI). After sending the new indication to the network, UE 201 may receive a registration accept message. The registration accept message may include a configured NSSAI and the network may include more than 16 slices in the configured NSSAI based on the indication that was provided by the UE in the Registration Request message. UE 201 may subsequently consider the more than 16 S-NSSAI as part of the configured NSSAI.

Alternatively, a new NAS information element may be defined. The new information element may be called “Configured NSSAI Extension” and may be an NSSAI Information Element Type as defined in TS 24.501 [1]. If UE 201 may be subscribed to more than 16 S-NSSAI, the network may send this new information element to UE 201 in the registration accept or UE configuration update message in order to provide UE 201 with configured slices beyond the 16 slices that were included in the configured NSSAI information of the registration accept or UE configuration update message. UE 201 may provide an indication to the network that it supports reception of the “Configured NSSAI Extension” information element. The indication may be sent to network by UE 201 in the registration request message and the indication may be encoded as part of the 5GMM Capability Information Element. UE 201 may consider any slices that are part of the “Configured NSSAI Extension” or the “Configured NSSAI” information elements to be part of the configured NSSAI. When a new configured NSSAI is sent to UE 201, UE 201 may indicate to the network how many S-NSSAI(s) UE 201 has stored as part of the configured NSSAI. The indication of how many S-NSSAI UE 201 has stored as part of the configured NSSAI may be sent to the network by UE 201 in the registration complete message or UE configuration update complete message. The indication of how many S-NSSAI UE 201 has stored may be sent by UE 201 to the network instead of requiring that UE 201 indicate that it is capable of storing more than 16 S-NSSAI in a configured NSSAI. If UE 201 sends no indication of how many S-NSSAIs were stored as part of the configured NSSAI, the network may assume that UE 201 can store no more than 16 S-NSSAI as part of the configured NSSAI.

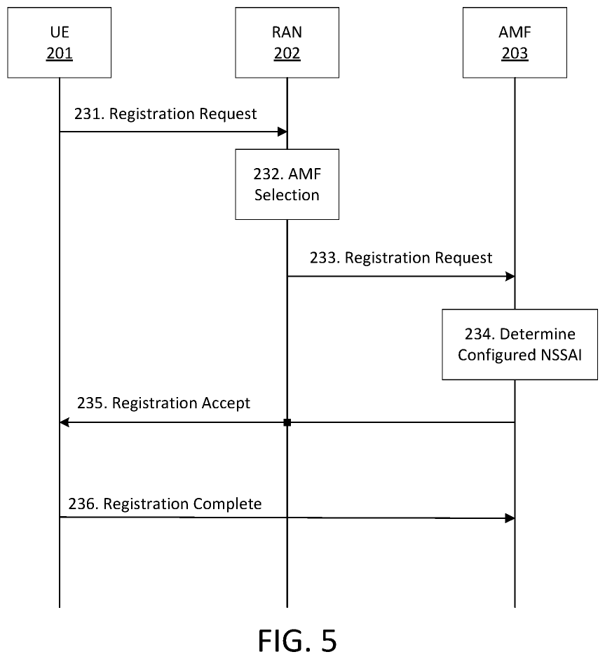

FIG. 5 and the associated description illustrates how the registration procedure may be adjusted so that the 5G system may support the case where UE 201 is subscribed to more than 16 slices and able to select slices from all of the UE's subscribed slices.

In step 231 of FIG. 5, UE 201 may send a registration request message to the network. The registration request may indicate to the network how many slices (e.g., S-NSSAIs) that UE 201 is capable of storing in the UE's Configured NSSAI. Alternatively, the registration request may indicate to the network that UE 201 is capable of receiving a “Configured NSSAI Extension” information element.

In step 232 of FIG. 5, RAN node 202 may perform AMF selection and may consider the UE's support for the “Configured NSSAI Extension” information element or how many configured slices UE 201 is capable of storing when selecting an AMF to serve UE 201.

In step 233 of FIG. 5, RAN node 202 may forward the registration request to the selected AMF. In step 234 of FIG. 5, the AMF obtains UE 201's subscribed slices from the UDM/UDR. If UE 201 is subscribed to more than 16 slices, then AMF 203 may determine to send only 16 slices to UE 201 in the UE 201's Configured NSSAI. For example, AMF 203 may determine to only send 16 Configured Slices to UE 201 if UE 201 did not indicate how many slices UE 201 is capable of storing in UE 201's configured NSSAI or if UE 201 did not indicate support for receiving a “Configured NSSAI Extension” information element. AMF 203 may instead determine to send UE 201 more than 16 slices in the UE 201's Configured NSSAI if UE 201 indicated that it is capable of storing more than 16 slices in UE 201's Configured NSSAI. AMF 2030 may also send the additional slices to UE 201 in a “Configured NSSAI Extension” information element if UE 201 indicated that it supports receiving the a “Configured NSSAI Extension” information element. If AMF 203 determines that the number of configured slices that UE 201 is capable of receiving is less than the number of configured slices, then AMF 203 may use local policies to determine which slices to select for UE 201's configured NSSAI or AMF 203 may determine which slices to select for the UE 201's Configured NSSAI based on information that is received from the UDM, for example.

In step 235 of FIG. 5, AMF 203 may send a registration accept message to UE 201. The registration accept message may include more than 16 slices in the configured NSSAI or a “Configured NSSAI Extension” information element.

In step 236 of FIG. 5, UE 201 may send registration complete message to AMF 203. The registration complete message may indicate to the network how many S-NSSAI value(s) UE 201 has stored as part of the configured NSSAI. It is contemplated herein that AMF 203 may be a primary AMF 204 or a secondary AMF 204. There may be scenarios in which the AMF that sends a message may be different than the one that responds.

UE 201 may provide a graphical user interface (GUI) that displays slices that UE 201 is able to access (e.g., the configured NSSAI). The GUI may indicate restrictions that are associated with access the slices. For example, the GUI may indicate to the user that 2 slices can never be accessed simultaneously. For example, the GUI may indicate to the user that 2 slices can be used simultaneously only if UE 201 associates separate NAS connections with each slice. The GUI may further indicate if UE 201 is capable of maintaining multiple NAS connections and associating separate NAS connections with each slice.

The GUI may further indicate a maximum number of slices that UE 201 may be configured to access (e.g., a maximum number of slices names (S-NSSAI) that may be stored in the UE's Configured NSSAI).

The information that is displayed in the GUI may be obtained by the terminal element (TE) mart of UE 201 from the MT part of UE 201 via one or more AT Commands.

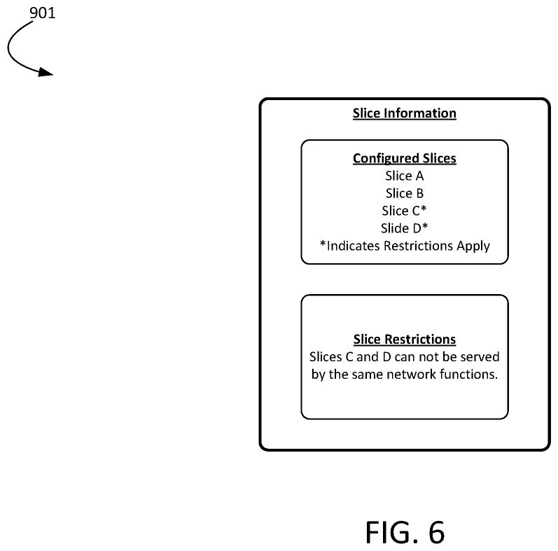

FIG. 6 illustrates an exemplary display (e.g., graphical user interface) that may be generated based on the methods, systems, and devices of architecture enhancements for network slicing, as discussed herein. Display interface 901 (e.g., touch screen display) may provide text associated with of architecture enhancements for network slicing, such related parameters, method flow, and associated current conditions. Progress of any of the steps (e.g., sent messages or success of steps) discussed herein may be displayed. In addition, graphical output may be displayed on display interface 901. Graphical output may be the topology of the devices implementing the methods, systems, and devices of architecture enhancements for network slicing, a graphical output of the progress of any method or systems discussed herein, or the like.

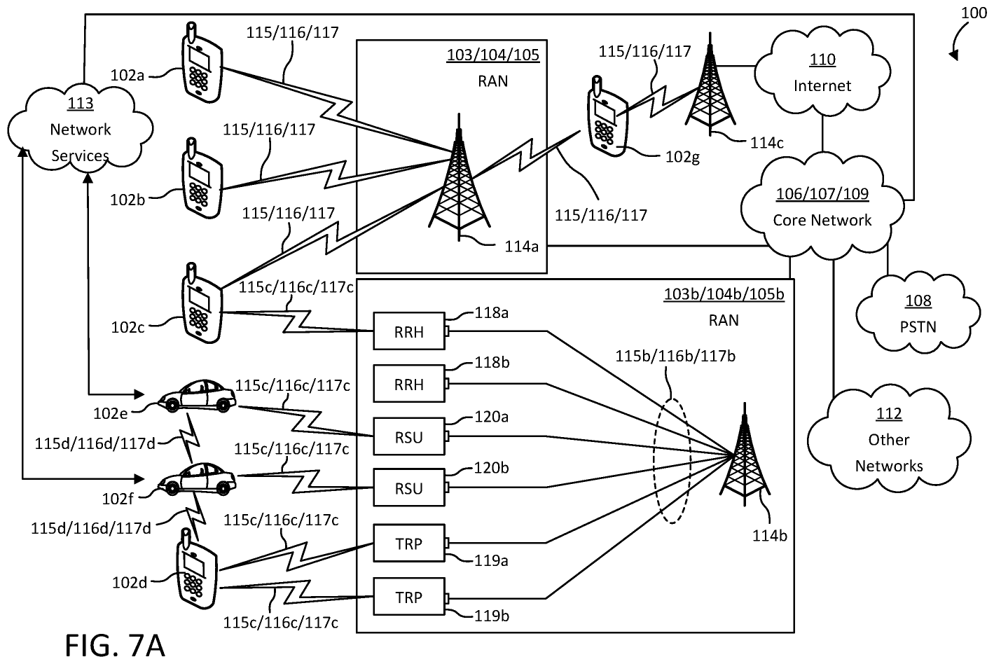

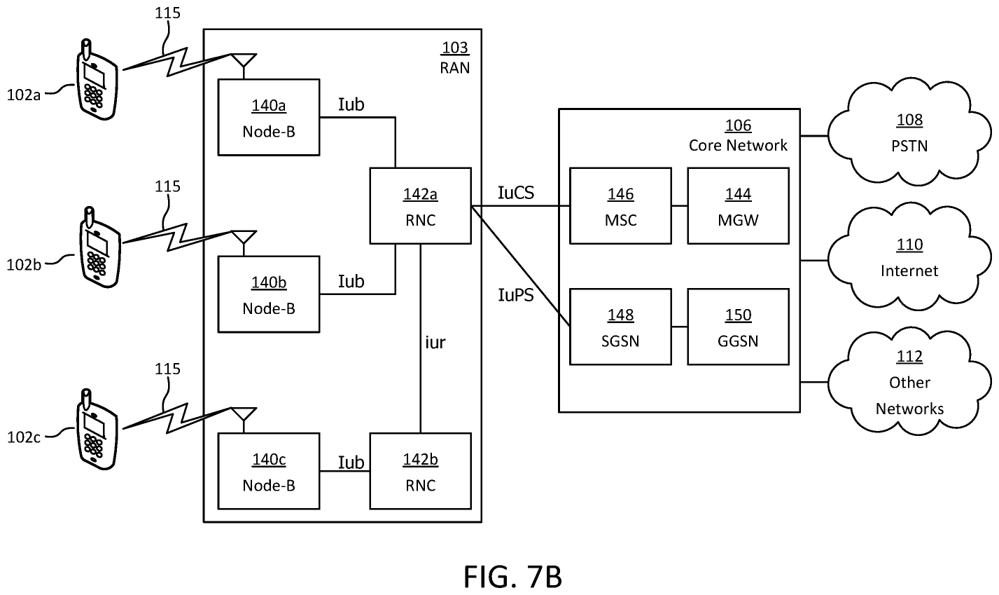

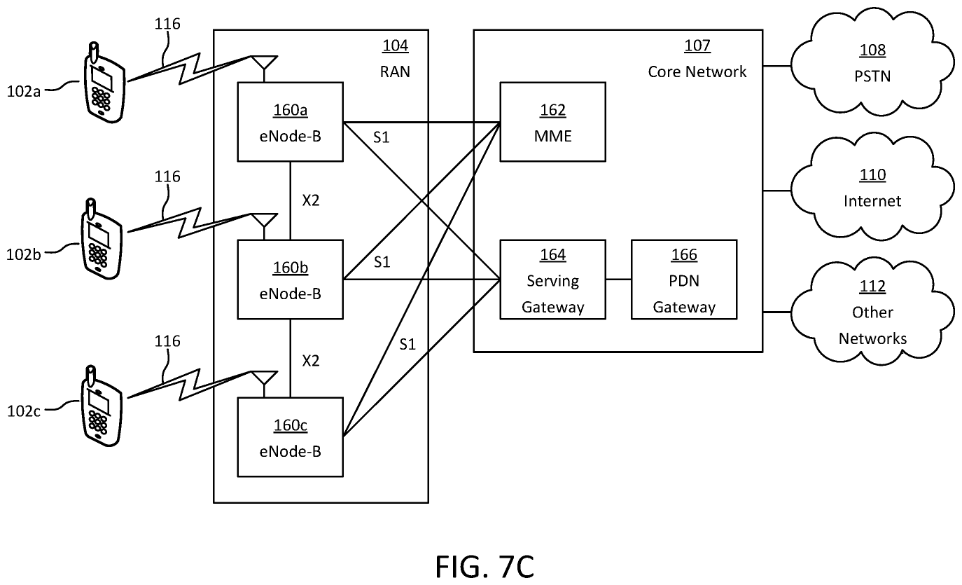

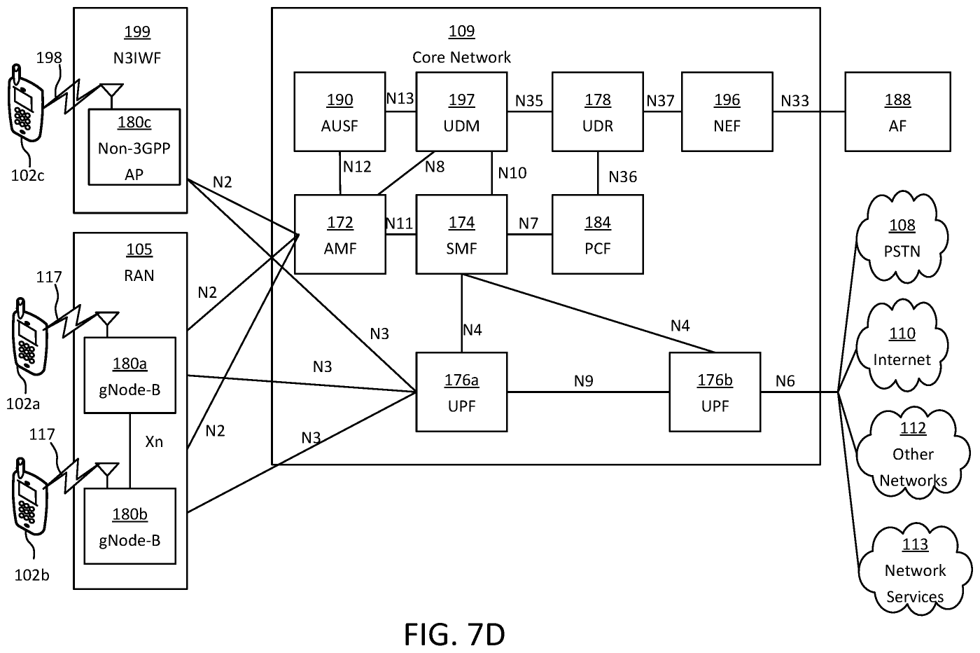

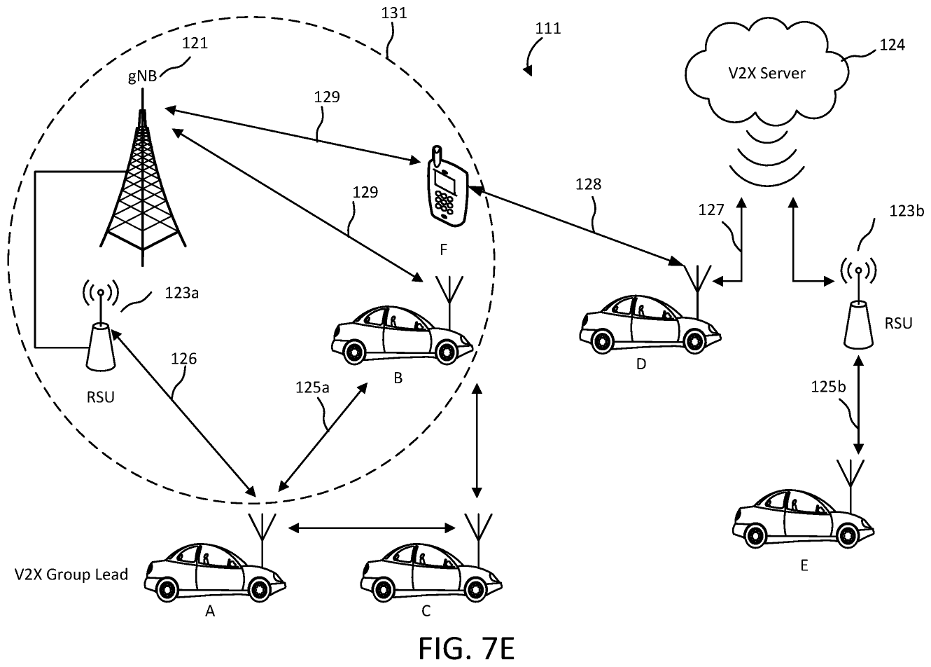

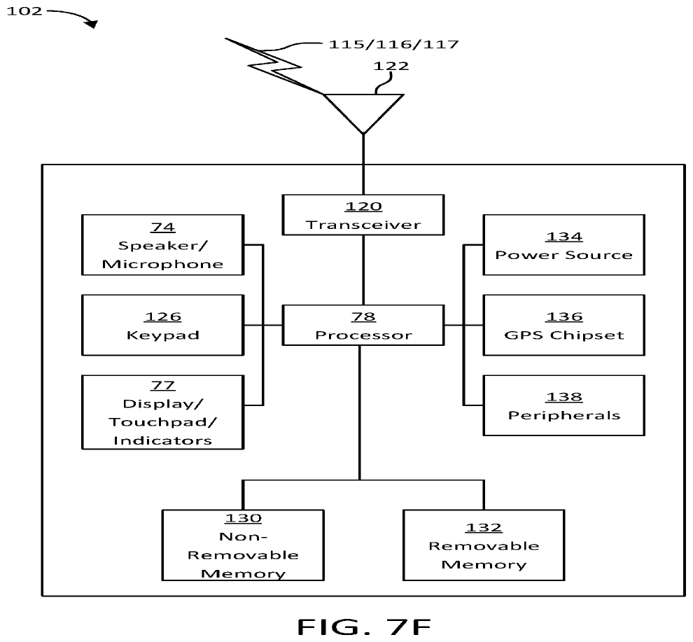

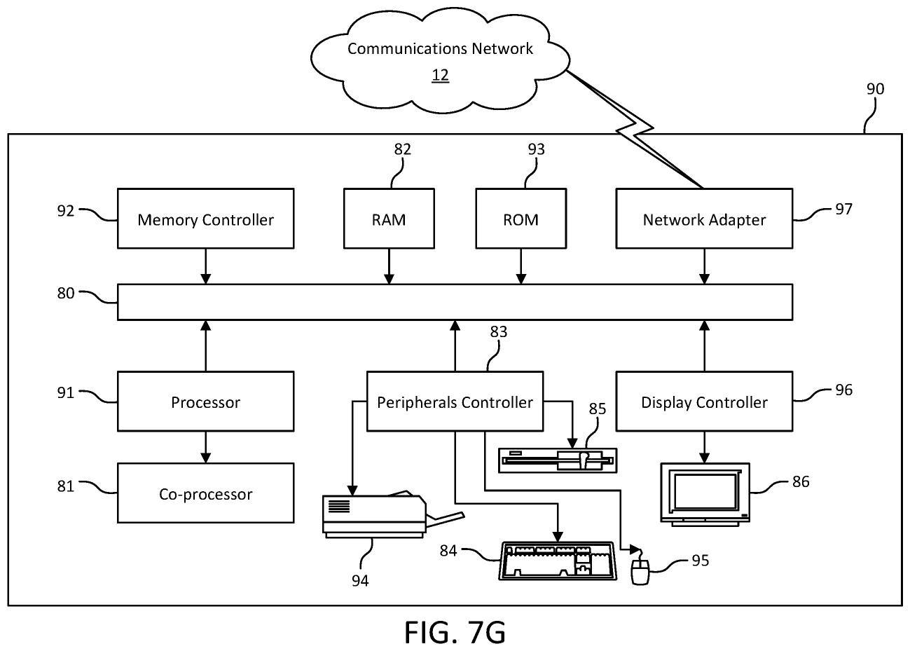

It is understood that the entities performing the steps illustrated herein, such as FIG. 1-FIG. 5, may be logical entities. The steps may be stored in a memory of, and executing on a processor of, a device, server, or computer system such as those illustrated in FIG. 7F or FIG. 7G. Skipping steps, combining steps, or adding steps between exemplary methods disclosed herein (e.g., FIG. 3-FIG. 5) is contemplated.

Herein the phrase “the UE will deregister from the slice” or the like is used. This phrase may indicate that when the slice is in the UE's Allowed NSSAI, E 201 may send a registration request to the network without including the slice in the requested NSSAI of the registration request.

Herein the phrase “the network will deregister the UE from the slice” or the like is used. This phrase may indicate that when the slice is in the UE's allowed NSSAI, the network may send a UE configuration update request to UE 201 without including the slice in the allowed NSSAI of the LE configuration update request.

Table 2 includes abbreviations and definitions of subject matter herein.

TABLE 2
Abbreviations and Definitions

| Abbreviations | Definitions |
|---|---|
| AMF | Access and Mobility Function |
| AN | Access Network |
| CM | Connection Management |
| eMBB | Enhanced Mobile Broadband |
| GUAMI | Globally Unique AMF ID |
| HPLMN | Home PLMN |
| MCC | Mobile Country Code |
| MNC | Mobile Network Code |
| MT | Mobile Termination |
| MIoT | Massive Internet of Things |
| NAS | Non-Access Stratum |
| NEF | Network Exposure Function |
| NF | Network Function |
| NRF | Network Repository Function |
| NSSAI | Network Slice Selection Assistance Information |
| N3GPP | Non-3GPP |
| PCF | Policy Control Function |
| PDU | Protocol Data Unit |
| PLMN | Public Land Mobile Network |
| RAN | Radio Access Network |
| RAT | Radio Access Technology |
| RM | Registration Management |
| RRC | Radio Resource Control |
| SD | Slice Differentiator |
| SMF | Session Management Function |
| S-NSSAI | Single NSSAI |
| SST | Slice/Service Type |
| TA | Tracking Area |
| TE | Terminal Equipment |
| TMSI | Temporary Mobile Subscriber Identity |
| UDM | User Data Management |
| UE | User Equipment |
| UPF | User Plane Function |
| URLLC | Ultra Reliable Low Latency Communications |
| VPLMN | Visited PLMN |
| V2X | Vehicle to Everything |
| 5GC | 5G Core Network |
| 5G-GUTI | 5G Global Unique Temporary Identifier |
| 5G-TMSI | 5G TMSI |
| 5G-S-TMSI | 5G S-TMSI |

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of anew, non-backwards compatible radio access in new spectrum below 6 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

FIG. 7A illustrates an example communications system 100 in which the methods and apparatuses of architecture enhancements for network slicing, such as the systems and methods illustrated in FIG. 1 through FIG. 5 described and claimed herein may be used. The communications system 100 may include wireless transmit/receive units (WTRUs) 102a, 102b, 102c, 102d, 102e, 102f, or 102g (which generally or collectively may be referred to as WTRU 102 or WTRUs 102). The communications system 100 may include, a radio access network (RAN) 103/104/105/103b/104b/105b, a core network 106/107/109, a public switched telephone network (PSTN) 108, the Internet 110, other networks 112, and Network Services 113. Network Services 113 may include, for example, a V2X server, V2X functions, a ProSe server, ProSe functions, IoT services, video streaming, or edge computing, etc.

It will be appreciated that the concepts disclosed herein may be used with any number of WTRUs, base stations, networks, or network elements. Each of the WTRUs 102a, 102b, 102c, 102d, 102e, 102f, or 102g may be any type of apparatus or device configured to operate or communicate in a wireless environment. Although each WTRU 102a, 102b, 102c, 102d, 102e, 102f, or 102g may be depicted in FIG. 7A, FIG. 7B, FIG. 7C, FIG. 7D, FIG. 7E, or FIG. 7F as a hand-held wireless communications apparatus, it is understood that with the wide variety of use cases contemplated for 5G wireless communications, each WTRU may comprise or be embodied in any type of apparatus or device configured to transmit or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus, truck, train, or airplane, and the like.

The communications system 100 may also include a base station 114a and a base station 114b. In the example of FIG. 7A, each base stations 114a and 114b is depicted as a single element. In practice, the base stations 114a and 114b may include any number of interconnected base stations or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, or the other networks 112. Similarly, base station 114b may be any type of device configured to wiredly or wirelessly interface with at least one of the Remote Radio Heads (RRHs) 118a, 118b, Transmission and Reception Points (TRPs) 119a, 119b, or Roadside Units (RSUs) 120a and 120b to facilitate access to one or more communication networks, such as the core network 106/107/109, the Internet 110, other networks 112, or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, or other networks 112

TRPs 119a, 119b may be any type of device configured to wirelessly interface with at least one of the WTRU 102d, to facilitate access to one or more communication networks, such as the core network 106/107/109, the Internet 110, Network Services 113, or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations or network elements (not shown), such as a Base Station Controller (BSC), a Radio Network Controller (RNC), relay nodes, etc. Similarly, the base station 114b may be part of the RAN 103b/104b/105b, which may also include other base stations or network elements (not shown), such as a BSC, a RNC, relay nodes, etc. The base station 114a may be configured to transmit or receive wireless signals within a particular geographic region, which may be referred to as a cell (not shown). Similarly, the base station 114b may be configured to transmit or receive wired or wireless signals within a particular geographic region, which may be referred to as a cell (not shown) for methods, systems, and devices of architecture enhancements for network slicing, as disclosed herein. Similarly, the base station 114b may be configured to transmit or receive wired or wireless signals within a particular geographic region, which may be referred to as a cell (not shown). The cell may further be divided into cell sectors. For example, the cell associated with the base station 114a may be divided into three sectors. Thus, in an example, the base station 114a may include three transceivers, e.g., one for each sector of the cell. In an example, the base station 114a may employ multiple-input multiple output (MIMO) technology and, therefore, may utilize multiple transceivers for each sector of the cell.

The base stations 114a may communicate with one or more of the WTRUs 102a, 102b, 102c, or 102g over an air interface 115/116/117, which may be any suitable wireless communication link (e.g., radio frequency (RF), microwave, infrared (TR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, or RSUs 120a, 120b, over a wired or air interface 115b/116b/117b, which may be any suitable wired (e.g., cable, optical fiber, etc.) or wireless communication link (e.g., radio frequency (RF), microwave, infrared (TR), ultraviolet (UV), visible light, cmWave, mmWave, etc.). The air interface 115b/116b/117b may be established using any suitable radio access technology (RAT).

The RRHs 118a, 118b, TRPs 119a, 119b or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (TR), ultraviolet (UV), visible light, cmWave, mmWave, etc.). The air interface 115c/116c/117c may be established using any suitable radio access technology (RAT).

The WTRUs 102a, 102b, 102c, 102d, 102e, or 102f may communicate with one another over an air interface 115d/116d/117d, such as Sidelink communication, which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b,TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) or Evolved HSPA (HSPA+). HSPA may include High-Speed Downlink Packet Access (HSDPA) or High-Speed Uplink Packet Access (HSUPA).

In an example, the base station 114a and the WTRUs 102a, 102b, 102c, or RRHs 118a, 118b, TRPs 119a, 119b, or RSUs 120a, 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) or LTE-Advanced (LTE-A). In the future, the air interface 115/116/117 or 115c/116c/117c may implement 3GPP NR technology. The LTE and LTE-A technology may include LTE D2D and V2X technologies and interfaces (such as Sidelink communications, etc.). Similarly, the 3GPP NR technology includes NR V2X technologies and interface (such as Sidelink communications, etc.).

The base station 114a in the RAN 103/104/105 and the WTRUs 102a, 102b, 102c, and 102g or RRHs 118a, 118b, TRPs 119a, 119b or RSUs 120a, 120b in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 7A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like, for implementing the methods, systems, and devices of architecture enhancements for network slicing, as disclosed herein. In an example, the base station 114c and the WTRUs 102, e.g., WTRU 102e, may implement a radio technology such as IEEE 802.11 to establish a wireless local area network (WLAN). similarly, the base station 114c and the WTRUs 102d, may implement a radio technology such as IEEE 802.15 to establish a wireless personal area network (WPAN). In yet another example, the base station 114c and the WTRUs 102, e.g., WTRU 102e, may utilize a cellular-based RAT (e.g., WCDMA, CDMA2000, GSM, LTE, LTE-A, NR, etc.) to establish a picocell or femtocell. As shown in FIG. 7A, the base station 114c may have a direct connection to the Internet 110. Thus, the base station 114c may not be required to access the Internet 110 via the core network 106/107/109.

The RAN 103/104/105 or RAN 103b/104b/105b may be in communication with the core network 106/107/109, which may be any type of network configured to provide voice, data, messaging, authorization and authentication, applications, or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, packet data network connectivity, Ethernet connectivity, video distribution, etc., or perform high-level security functions, such as user authentication.

Although not shown in FIG. 7A, it will be appreciated that the RAN 103/104/105 or RAN 103b/104b/105b or the core network 106/107/109 may be in direct or indirect communication with other RANs that employ the same RAT as the RAN 103/104/105 or RAN 103b/104b/105b or a different RAT. For example, in addition to being connected to the RAN 103/104/105 or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102a, 102b, 102c, 102d, 102e to access the PSTN 108, the Internet 110, or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned or operated by other service providers. For example, the networks 112 may include any type of packet data network (e.g., an IEEE 802.3 Ethernet network) or another core network connected to one or more RANs, which may employ the same RAT as the RAN 103/104/105 or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links for implementing methods, systems, and devices of architecture enhancements for network slicing, as disclosed herein. For example, the WTRU 102g shown in FIG. 7A may be configured to communicate with the base station 114a, which may employ a cellular-based radio technology, and with the base station 114c, which may employ an IEEE 802 radio technology.

Although not shown in FIG. 7A, it will be appreciated that a User Equipment may make a wired connection to a gateway. The gateway maybe a Residential Gateway (RG). The RG may provide connectivity to a Core Network 106/107/109. It will be appreciated that much of the subject matter included herein may equally apply to UEs that are WTRUs and UEs that use a wired connection to connect with a network. For example, the subject matter that applies to the wireless interfaces 115, 116, 117 and 115c/116c/117c may equally apply to a wired connection.

FIG. 7B is a system diagram of an example RAN 103 and core network 106 that may implement methods, systems, and devices of architecture enhancements for network slicing, as disclosed herein. As noted above, the RAN 103 may employ a UTRA radio technology to communicate with the WTRUs 102a, 102b, and 102c over the air interface 115. The RAN 103 may also be in communication with the core network 106. As shown in FIG. 7B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 7B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 7B may include a media gateway (MGW) 144, a Mobile Switching Center (MSC) 146, a Serving GPRS Support Node (SGSN) 148, or a Gateway GPRS Support Node (GGSN) 150. While each of the foregoing elements are depicted as part of the core network 106, it will be appreciated that any one of these elements may be owned or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned or operated by other service providers.

FIG. 7C is a system diagram of an example RAN 104 and core network 107 that may implement methods, systems, and devices of architecture enhancements for network slicing, as disclosed herein. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink or downlink, and the like. As shown in FIG. 7C, the eNode-Bs 160a, 160b, and 160c may communicate with one another over an X2 interface.

The core network 107 shown in FIG. 7C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned or operated by other service providers.

FIG. 7D is a system diagram of an example RAN 105 and core network 109 that may implement methods, systems, and devices of architecture enhancements for network slicing, as disclosed herein. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink or downlink, and the like. As shown in FIG. 7D, the gNode-Bs 180a and 180b may communicate with one another over an Xn interface, for example.

The core network 109 shown in FIG. 7D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless or network communications or a computer system, such as system 90 illustrated in FIG. 7G.

In the example of FIG. 7D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned or operated by an entity other than the core network operator. It will also be appreciated that a 5G core network may not consist of all of these elements, may consist of additional elements, and may consist of multiple instances of each of these elements. FIG. 7D shows that network functions directly connect with one another, however, it should be appreciated that they may communicate via routing agents such as a diameter routing agent or message buses.

In the example of FIG. 7D, connectivity between network functions is achieved via a set of interfaces, or reference points. It will be appreciated that network functions could be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 7D.

The SMF 174 may be connected to the AMF 172 via an N11 interface. Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 7D. The PCF 184 may provide policy rules to control plane nodes such as the AMF 172 and SMF 174, allowing the control plane nodes to enforce these rules. The PCF 184, may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect with network functions, so that network function can add to, read from, and modify the data that is in the repository. For example, the UDR 178 may connect with the PCF 184 via an N36 interface. Similarly, the UDR 178 may connect with the NEF 196 via an N37 interface, and the UDR 178 may connect with the UDM 197 via an N35 interface.

The UDM 197 may serve as an interface between the UDR 178 and other network functions. The UDM 197 may authorize network functions to access of the UDR 178. For example, the UDM 197 may connect with the AMF 172 via an N8 interface, the UDM 197 may connect with the SMF 174 via an N10 interface. Similarly, the UDM 197 may connect with the AUSF 190 via an N13 interface. The UDR 178 and UDM 197 may be tightly integrated.

The AUSF 190 performs authentication related operations and connect with the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect with an AF 188 via an N33 interface and it may connect with other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 7D, in a network slicing scenario, a WTRU 102a, 102b, or 102c may connect with an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned or operated by other service providers.

The core network entities described herein and illustrated in FIG. 7A, FIG. 7C, FIG. 7D, or FIG. 7E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIG. 7A, FIG. 7B, FIG. 7C, FIG. 7D, or FIG. 7E are provided by way of example only, and it is understood that the subject matter disclosed and claimed herein may be embodied or implemented in any similar communication system, whether presently defined or defined in the future.

FIG. 7E illustrates an example communications system 111 in which the systems, methods, apparatuses that implement architecture enhancements for network slicing, described herein, may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 7E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 7E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 7F is a block diagram of an example apparatus or device WTRU 102 that may be configured for wireless communications and operations in accordance with the systems, methods, and apparatuses that implement architecture enhancements for network slicing, described herein, such as a WTRU 102 of FIG. 7A, FIG. 7B, FIG. 7C, FIG. 7D, or FIG. 7E, or FIG. 3-FIG. 5 (e.g., UE, RAN, or UE AMF). As shown in FIG. 7F, the example WTRU 102 may include a processor 78, a transceiver 120, a transmit/receive element 122, a speaker/microphone 74, a keypad 126, a display/touchpad/indicators 77, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 7F and may be an exemplary implementation that performs the disclosed systems and methods for architecture enhancements for network slicing described herein.

The processor 78 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 78 may perform signal coding, data processing, power control, input/output processing, or any other functionality that enables the WTRU 102 to operate in a wireless environment. The processor 78 may be coupled to the transceiver 120, which may be coupled to the transmit/receive element 122. While FIG. 7F depicts the processor 78 and the transceiver 120 as separate components, it will be appreciated that the processor 78 and the transceiver 120 may be integrated together in an electronic package or chip.

The transmit/receive element 122 of a UE may be configured to transmit signals to, or receive signals from, a base station (e.g., the base station 114a of FIG. 7A) over the air interface 115/116/117 or another UE over the air interface 115d/116d/117d. For example, the transmit/receive element 122 may be an antenna configured to transmit or receive RF signals. The transmit/receive element 122 may be an emitter/detector configured to transmit or receive IR, UV, or visible light signals, for example. The transmit/receive element 122 may be configured to transmit and receive both RF and light signals. It will be appreciated that the transmit/receive element 122 may be configured to transmit or receive any combination of wireless or wired signals.

In addition, although the transmit/receive element 122 is depicted in FIG. 7F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 78 of the WTRU 102 may be coupled to, and may receive user input data from, the speaker/microphone 74, the keypad 126, or the display/touchpad/indicators 77 (e.g., a liquid crystal display (LCD) display unit or organic light-emitting diode (OLED) display unit. The processor 78 may also output user data to the speaker/microphone 74, the keypad 126, or the display/touchpad/indicators 77. In addition, the processor 78 may access information from, and store data in, any type of suitable memory, such as the non-removable memory 130 or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 78 may access information from, and store data in, memory that is not physically located on the WTRU 102, such as on a server that is hosted in the cloud or in an edge computing platform or in a home computer (not shown). The processor 78 may be configured to control lighting patterns, images, or colors on the display or indicators 77 in response to whether the methods described herein are successful or unsuccessful, or otherwise indicate a status of architecture for network slicing and associated components. The control lighting patterns, images, or colors on the display or indicators 77 may be reflective of the status of any of the method flows or components in the FIG.'s illustrated or discussed herein (e.g., FIG. 3-FIG. 5, etc.). Disclosed herein are messages and procedures of network slicing. The messages and procedures may be extended to provide interface/API for users to request resources via an input source (e.g., speaker/microphone 74, keypad 126, or display/touchpad/indicators 77) and request, configure, or query network slicing related information, among other things that may be displayed on display 77.

The processor 78 may receive power from the power source 134 and may be configured to distribute or control the power to the other components in the WTRU 102. The power source 134 may be any suitable device for powering the WTRU 102. For example, the power source 134 may include one or more dry cell batteries, solar cells, fuel cells, and the like.

The processor 78 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) or determine its location based on the timing of the signals being received from two or more nearby base stations. It will be appreciated that the WTRU 102 may acquire location information by way of any suitable location-determination method.

The processor 78 may further be coupled to other peripherals 138, which may include one or more software or hardware modules that provide additional features, functionality, or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect with other components, modules, or systems of such apparatuses or devices via one or more interconnect interfaces, such as an interconnect interface that may comprise one of the peripherals 138.

FIG. 7G is a block diagram of an exemplary computing system 90 in which one or more apparatuses of the communications networks illustrated in FIG. 7A, FIG. 7C, FIG. 7D and FIG. 7E as well as architecture for network slicing, such as the systems and methods illustrated in FIG. 3 through FIG. 5 described and claimed herein may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, or any other functionality that enables the computing system 90 to operate in a communications network. Coprocessor 81 may be a processor, distinct from main processor 91, that may perform additional functions or assist processor 91. Processor 91 or coprocessor 81 may receive, generate, and process data related to the methods and apparatuses disclosed herein for network slicing.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally include stored data that cannot easily be modified. Data stored in RAM 82 may be read or changed by processor 91 or other hardware devices. Access to RAM 82 or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may include peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may include communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIG. 7A, FIG. 7B, FIG. 7C, FIG. 7D, or FIG. 7E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 78 or 91, cause the processor to perform or implement the systems, methods and processes described herein. Specifically, any of the steps, operations, or functions described herein may be implemented in the form of such computer executable instructions, executing on the processor of an apparatus or computing system configured for wireless or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

In describing preferred methods, systems, or apparatuses of the subject matter of the present disclosure—architecture enhancements for network slicing—as illustrated in the Figures, specific terminology is employed for the sake of clarity. The claimed subject matter, however, is not intended to be limited to the specific terminology so selected.

The various techniques described herein may be implemented in connection with hardware, firmware, software or, where appropriate, combinations thereof. Such hardware, firmware, and software may reside in apparatuses located at various nodes of a communication network. The apparatuses may operate singly or in combination with each other to effectuate the methods described herein. As used herein, the terms “apparatus,” “network apparatus,” “node,” “device,” “network node,” or the like may be used interchangeably. In addition, the use of the word “or” is generally used inclusively unless otherwise provided herein.

This written description uses examples for the disclosed subject matter, including the best mode, and also to enable any person skilled in the art to practice the disclosed subject matter, including making and using any devices or systems and performing any incorporated methods. The disclosed subject matter may include other examples that occur to those skilled in the art (e.g., skipping steps, combining steps, or adding steps between exemplary methods disclosed herein).

Methods, systems, and apparatuses, among other things, as described herein may provide for sending, a registration request, wherein the registration request comprises an indication of a plurality of network slices; and receiving a registration accept message, wherein the registration accept message indicates that one or more of the plurality of network slices are allowed and at least one of the plurality of network slices is rejected, wherein the registration accept message further indicates that a slice was rejected based on the access and mobility management function (AMF) cannot serve the rejected slice and the one or more of the allowed network slices. Methods, systems, and apparatuses may provide for sending a second registration request, wherein the second registration request: indicates a request of the rejected slice, and indicates a preference to maintain a registration with the AMF or establish a registration with a second AMF. Methods, systems, and apparatuses may provide for receiving a first 5G-S-TMSI for the first AMF; receiving a second 5G-S-TMSI for the second AMF; sending the first 5G-S-TMSI to the second AMF; monitoring a paging occasion that is associated with the first 5G-S-TMSI; and based on the monitoring of the paging occasion, receiving a paging message that includes second 5G-S-TMSI. Methods, systems, and apparatuses may provide for sending a Registration Request to an AMF, wherein: a RAN performs AMF selection, and the RAN forward the NAS Registration request to the selected AMF, wherein the AMF determines, based on local policies, that at least some of the requested slices are not able to be served by the same AMF; and receiving the Registration Accept message. Methods, systems, and apparatuses may provide for receiving, from a wireless transmit/receive unit (WTRU) by a radio access network (RAN), a registration request, the registration request for an access and mobility management function, wherein the registration request comprises an indication of one or more network slices; based on the registration request, selecting, by the RAN, the access and mobility management function (AMF); and forwarding, by the RAN, the registration request to the AMF, wherein the AMF determines, based on one or more local policies, that at least one of the one or more slices are not able to be served by the same AMF; receiving a registration accept message; and forwarding the registration accept message to the WTRU. All combinations in this paragraph (including the removal or addition of steps) are contemplated in a manner that is consistent with the other portions of the detailed description.

Methods, systems, and apparatuses, among other things, as described herein may provide for sending, by a wireless transmit/receive unit (WTRU), a registration request may be from a first network node, wherein the registration request may comprise an indication of a plurality of network slices; receiving a registration accept message, wherein the registration accept message may indicate that one or more of the plurality of network slices may be allowed with the first network node and at least one of the plurality of network slices is rejected, wherein the registration accept message may indicate that a slice was rejected based on the first network node being unable to serve the rejected slice and the one or more of the allowed network slices; and sending a second registration request for a second network node, wherein the second registration request: may indicate a request for the rejected slice, or may indicate maintaining a connection (e.g., NAS connection) or registration with the first network node. The first network node may be a first access and mobility management function (AMF) and the second network node may be a second AMF. A registration type may be set to a value that indicates the registration is for a slice addition. Methods, systems, and apparatuses, among other things, as described herein may provide for sending a second registration request message to a second AMF, wherein the second registration request message indicates a preference to maintain a first non-access stratum (NAS) connection with the first AMF and the second registration request message comprises a second requested NSSAI. All combinations in this paragraph and the previous paragraph (including the removal or addition of steps) are contemplated in a manner that is consistent with the other portions of the detailed description.

Methods, systems, and apparatuses, among other things, as described herein may provide for receiving a first registration request message from a wireless transmit/receive unit (WTRU), wherein the first registration request message comprises a first requested network slice selection assistance information (NSSAI), wherein the first requested NSSAI comprises an indication of a plurality of network slices, wherein the first registration request message comprises a first 5G-S-temporary mobile subscriber identity (TMSI), wherein the first registration request message indicates a preference to maintain a first non-access stratum (NAS) connection with a first Access and Mobility Management Function (AMF); sending a registration accept message to the WTRU, wherein the registration accept message indicates that one or more network slice of the plurality of network slices are allowed, wherein the registration accept message comprises a second 5G-S-TMSI; and sending a paging request to a radio access network (RAN) node to request that the WTRU be paged, wherein the paging request comprises the first 5G-S-TMSI and the second 5G-S-TMSI. All combinations in this paragraph and the previous paragraph (including the removal or addition of steps) are contemplated in a manner that is consistent with the other portions of the detailed description.

What is claimed is:

1-20. (canceled)

21. A wireless transmit/receive unit (WTRU) comprising a processor configured to:
send a first registration request message, wherein the first registration request message comprises a requested network slice selection assistance information (NSSAI), wherein the requested NSSAI comprises an indication of a plurality of network slices;
receive a registration accept message, wherein the registration accept message indicates that one or more of the plurality of network slices are allowed with a first access and mobility management function (AMF) and at least one of the plurality of network slices is rejected, wherein the registration accept message further indicates that the rejected network slice was rejected based on the first AMF being unable to serve the rejected network slice and the one or more of the allowed network slices; and
send a second registration request message to a second AMF, wherein the second registration request message indicates a preference to maintain a first non-access stratum (NAS) connection with the first AMF, and wherein the second registration request message comprises a second requested NSSAI, wherein the second requested NSSAI indicates a request for the rejected network slice.

22. The WTRU of claim 21, wherein the processor is further configured to:
receive a first 5G-S-temporary mobile subscriber identity (5G-S-TMSI) from the first AMF;
receive a second 5G-S-TMSI from the second AMF;
send the first 5G-S-TMSI to the second AMF;
determine a paging occasion that is associated with the first 5G-S-TMSI; and
based on the determined paging occasion, receive a paging message comprising the second 5G-S-TMSI.

23. The WTRU of claim 22, wherein the first 5G-S-TMSI is sent to the second AMF in the second registration request message.

24. The WTRU of claim 21, wherein the processor is further configured to set a registration type to a value that indicates the second registration request message is for a network slice addition.

25. The WTRU of claim 21, wherein the processor is further configured to:
communicate with the first AMF via the first NAS connection; and
communicate with the second AMF a via a second NAS connection.

26. The WTRU of claim 21, wherein the first registration request message further comprises an indication that the WTRU is capable of maintaining a simultaneous registration with more than one AMF.

27. The WTRU of claim 21, wherein the first registration request message further comprises an indication of a number of connection management (CM) states that the WTRU is capable of simultaneously maintaining.

28. The WTRU of claim 21, wherein each of the plurality of network slices is associated with one or more network functions and a respective service type.

29. A method performed by a wireless transmit/receive unit (WTRU), the method comprising:
sending, by the WTRU, a first registration request message, wherein the first registration request message comprises a requested network slice selection assistance information (NSSAI), wherein the requested NSSAI comprises an indication of a plurality of network slices;
receiving a registration accept message, wherein the registration accept message indicates that one or more of the plurality of network slices are allowed with a first access and mobility management function (AMF) and at least one of the plurality of network slices is rejected, wherein the registration accept message further indicates that the rejected network slice was rejected based on the first AMF being unable to serve the rejected slice and the one or more of the allowed network slices; and
sending a second registration request message to a second AMF, wherein the second registration request message indicates a preference to maintain a first non-access stratum (NAS) connection with the first AMF and the second registration request message comprises a second requested NSSAI, wherein the second requested NSSAI:
indicates a request for the rejected slice.

30. The method of claim 29, further comprising:
receiving a first 5G-S-temporary mobile subscriber identity (5G-S-TMSI) from the first AMF;
receiving a second 5G-S-TMSI from the second AMF;
sending the first 5G-S-TMSI to the second AMF;
checking a paging occasion that is associated with the first 5G-S-TMSI; and
based on the checking of the paging occasion, receiving a paging message that includes second 5G-S-TMSI.

31. The method of claim 30, wherein the first 5G-S-TMSI is sent to the second AMF in the second registration request message.

32. The method of claim 29, wherein the method further comprises setting a registration type to a value that indicates the second registration request message is for a slice addition.

33. The method of claim 29, further comprising:
communicating with the first AMF via the first NAS connection; and
communicating with the second AMF via a second NAS connection.

34. The method of claim 29, wherein the first registration request message further comprises an indication that the WTRU is capable of simultaneously maintaining a registration with more than one AMF.

35. The method of claim 29, wherein the first registration request message further comprises an indication of a number of connection management (CM) states that the WTRU is capable of simultaneously maintaining.

36. A method performed by a network node, the method comprising:
receiving, from a wireless transmit/receive unit (WTRU), a first registration request message, wherein the first registration request message comprises a requested network slice selection assistance information (NSSAI) and a first 5G-S-temporary mobile subscriber identity (5G-S-TMSI), wherein the requested NSSAI comprises an indication of a plurality of network slices, and wherein the first registration request message indicates a preference to maintain a first non-access stratum (NAS) connection with a first Access and Mobility Management Function (AMF);
sending, to the WTRU, a registration accept message, wherein the registration accept message indicates that one or more network slices of the plurality of network slices are allowed, and wherein the registration accept message comprises a second 5G-S-TMSI; and
sending a paging request to a radio access network (RAN) node to request that the WTRU be paged, wherein the paging request comprises the first 5G-S-TMSI and the second 5G-S-TMSI.

37. The method of claim 36, wherein the first 5G-S-TMSI in the paging request is indicative of a paging occasion, and wherein the second 5G-S-TMSI in the paging request is indicative of a value that is to be placed in a paging message.

38. The method of claim 36, further comprising receiving, from the WTRU, a message that indicates that the first 5G-S-TMSI has changed to a third 5G-S-TMSI, wherein the message comprises the third 5G-S-TMSI.

39. The method of claim 36, further comprising receiving, from the first AMF, a notification, wherein the notification indicates the WTRU is in a connected state or an idle state.

40. The method of claim 36, wherein the method is performed by a second AMF.
